(19) United States
(12) Patent Application Publication
(10) Pub. No.: US 2002/0078726 A1
(43) Pub. Date: Jun. 27, 2002

(54) Gearshift interlock device

(76) Inventor: Lynthia A. Muller, Solvang, CA (US)

Correspondence Address: LYNTHIA MULLER, 332 NYKOBING, SOLVANG, CA, 93463, US

(21) Appl. No.: 09/963,943

(22) Filed: Nov. 27, 2001

Related U.S. Application Data
(60) Provisional application No. 60/232,229, filed on Sep. 12, 2000.

(51) Int. Cl. B60R 25/06

(52) U.S. Cl. 70/247

(57) ABSTRACT

A vehicle safety device for insuring that occupants of a vehicle are wearing a seat belt that includes a gear shift interlock mechanism including a locking mechanism for engaging the gear shift lever of a vehicle which is controlled by a controlling having a sensor provided on each of the seats of a vehicle. When the sensor generates a signal indicating that a person is seated on the seat, the controller waits to receive a buckling signal from the seat belt before allowing the user to move the gear shift. If the buckling sensor does not detect a buckling after the weight sensor is triggered then the locking mechanism does not unlock until the seat belt unbuckled and then rebuckled.

### TECHNICAL FIELD

The present invention relates to vehicle safety equipment and more particularly to a gearshift interlock device that includes a locking mechanism controlled by a controller having a sensor provided on each of the seats of the vehicle which determines whether a weight is positioned on the seat of sufficient magnitude to require fastening of the seat belt; should the weight sensor detect a triggering weight, the control device prevents the locking mechanism from disengaging and the vehicle operator from shifting the gear into drive or reverse.

### BACKGROUND OF INVENTION

It is important in order to insure the safety of all the passengers of a car that each of the passengers has attached his/her safety belt prior to driving a vehicle. It would be a benefit, therefore, to have a system which would detect the presence of a passenger in a seat and prevent the vehicle gear shift from being shifted into a drive or reverse position until the seat belt for that particular seat has been engaged. The control circuit could also be programmed to detect that the seat belt has been buckled after the triggering weight has been detected to prevent defeating of the system by merely keeping the seat belt buckles buckled at all times.

### SUMMARY OF INVENTION

It is thus an object of the invention to provide a gear shift interlock device that includes a locking mechanism controlled by a controller having a sensor provided on each of the seats of the vehicle which determines whether a weight is positioned on the seat of sufficient magnitude to require fastening of the seat belt; should the weight sensor detect a triggering weight, the control device prevents the locking mechanism from disengaging and the vehicle operator from shifting the gear into drive or reverse.

Accordingly, a gear shift interlock device is provided. The gear shift interlock device includes a locking mechanism controlled by a controller having a sensor provided on each of the seats of the vehicle which determines whether a weight is positioned on the seat of sufficient magnitude to require fastening of the seat belt; should the weight sensor detect a triggering weight, the control device prevents the locking mechanism from disengaging and the vehicle operator from shifting the gear into drive or reverse.

It can be seen from the preceding description that a gear shift interlock device has been provided.

It is noted that the embodiment of the a gear shift interlock device described herein in detail for exemplary purposes is of course subject to many different variations in structure; design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows an exemplary embodiment of the interior of a vehicle including the gear shift locking device system of the present invention.

### EXEMPLARY EMBODIMENTS

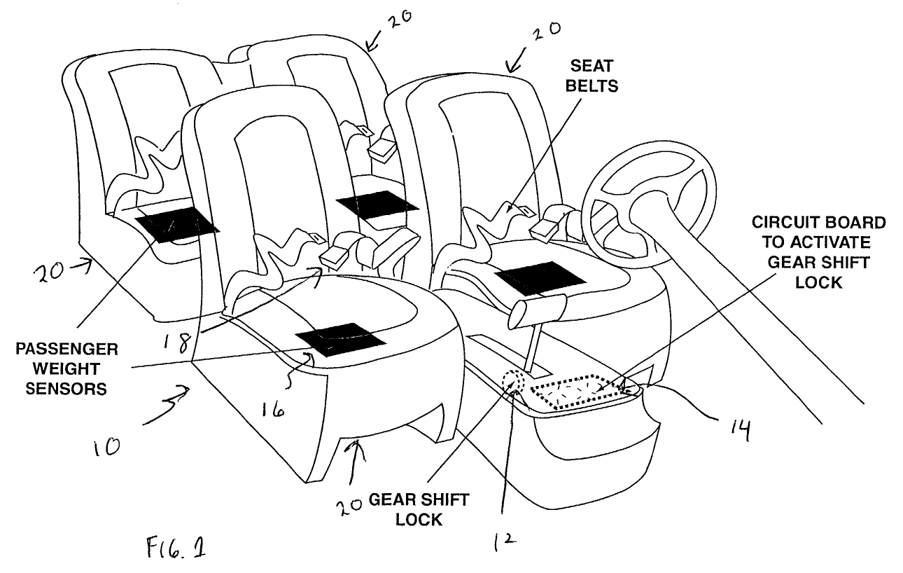

FIG. 1 shows an exemplary embodiment of the gear shift interlock device of the present invention generally designated 10. Gear shift interlock device 10 includes a locking mechanism 12 that is controlled by a circuit board 14 in connection with a number of passenger weight sensors 16 and seat belt sensors 18 that are provided for each of the seats 20 of the vehicle. Circuit board 14 is programmed to prevent gear shift lock from disengaging when weight is sensed on a seat and the seat belt buckle has not been buckled after the weight has been sensed. Programming circuit board 14 in this manner prevents the bypassing of the gear shift interlock device by simply maintaining all the seat buckles in a buckled configuration.

What is claimed is:

1. A vehicle safety device comprising:
a gearshift/transmission solenoid lock mechanism for the gearshift;
weight sensors;
seatbelt sensors;
an electronic circuit board
an outer case containing solenoid
a transmission case
said gearshift transmission solenoid locking mechanism has a sensor on each seat and has a control device connecting to a locking mechanism; said gearshift locking device has a shifter lock shaft, part of the locking solenoid This shaft is extended by the solenoid and retracted by a return spring; said gearshift/transmission locking mechanism is contained in an outer case.
said outer case contains engaging coil, power cable, return spring, spring retainer, and lock shaft; the return spring in the outer case is contained in the spring retainer. The lock shaft extends from engaging coil to spring container;
said solenoid will drive locking pin into cavity in shifter level and said solenoid will be mounted on solenoid mount;
in said transmission shifter lock shaft will be connected to shifter lever, and shifter cable will connect to shifter cable mount;
said solenoid in transmission case will contain shifter lock shaft which connects to shifter lever; said shifter lever will have shifter lever pivot connected; solenoid mount will contain solenoid; said solenoid will connect to solenoid drives, power cable from solenoid driver will connect to solenoid;
said transmission pan will contain solenoid and solenoid mount;
said microprocessor will contain program to poll weight sensors and seatbelt sensors, check conditions, operate output devices, and poll emergency override 10 button; said weight sensors will connect to the sensor isolator, and then connect to microprocessor; the buzzer relay will receive input from the microprocessor to relay information to the buzzer driver.
